(19) United States
(12) Patent Application Publication
(10) Pub. No.: US 2011/0218698 A1
(43) Pub. Date: Sep. 8, 2011

(54) HYBRID HIGH VOLTAGE ISOLATION CONTACTOR CONTROL

(75) Inventor: Jay E. Bissontz, Fort Wayne, IN (US)

(73) Assignee: International Truck Intellectual Property Company, LLC, Warrenville, IL (US)

(21) Appl. No.: 12/717,600

(22) Filed: Mar. 4, 2010

(51) Int. Cl. B60L 11/00; B60W 20/00

(52) U.S. Cl. 701/22; 180/65.29

(57) ABSTRACT

An isolation system for traction batteries for a vehicle includes battery contactors having a closed state and an open state. The current drawn from the traction batteries during transitions between the two states is managed by selecting loads for either reduced levels of operation or cutoff to reduce the total current draw. Vehicle operating conditions, such as the direction of the state transition, may control the selection of loads for operation during the transition.

### BACKGROUND

1. Technical Field

The technical field relates generally to electric vehicles and hybrid-electric vehicles and, more particularly, to control over high voltage battery isolation contactors.

2. Description of the Problem

Electric and hybrid electric vehicles carry relatively high voltage battery plants (traction batteries) for supplying power to vehicle traction motors and other vehicle electrical systems. Traction batteries typically have a nominal output voltage sufficient to support of 340 volt rms three phase power, and in some cases 700 volts rms power, from an inverter. In contrast, conventional automotive batteries supply voltage at about 12 volts DC.

The traction battery plant is usually physically isolated in its own compartment to avoid inadvertent exposure of high voltages to people working on the vehicle. Contactors, which functionally are analogous to circuit breakers, are provided within the compartment for selectively connecting and disconnecting the battery plant from the vehicle electrical system. Under some circumstances the battery plant is electrically isolated by opening the contactors within the compartment to prevent high voltages from appearing at points on the vehicle electrical system outside the battery compartment.

Electric and hybrid electric vehicles make more extensive use of electrical power than do conventional vehicles to support vehicle functions such as power steering or air conditioning compressor operation from electric motors. On an electric vehicle this is largely unavoidable. On a hybrid vehicle using electric motors to operate an air conditioning or power steering pump makes these functions operationally independent of the vehicle's internal combustion engine. In addition, contemporary vehicles make extensive use of electronic computers which are consumers of electrical power. As a result, current loads on vehicle traction batteries can become quite high.

High current loads can compromise fraction battery isolation contactor service life. Relatively high currents, on the order of hundreds of amps, can be drawn by a vehicle if many or all of the vehicle's potential electrical loads are active. Contactor arcing during opening and particularly on closing can result in isolation contactor degradation and in the development of welds during closing which can hold the contactors in the closed position. Such a result compromises the contactor's isolation function.

### SUMMARY

An isolation system for traction batteries for a vehicle includes battery contactors having a closed state and an open state. The current drawn from the traction batteries during transitions between the two states is managed by selecting loads for either reduced levels of operation or cutoff to reduce the total current draw. Vehicle operating conditions, such as the direction of the state transition, may control the selection of loads for operation during the transition.

### BRIEF DESCRIPTION OF THE DRAWINGS

FIG. 1 is a high level schematic of a vehicle drive train and vehicle control system for a hybrid-electric vehicle.

### DETAILED DESCRIPTION

In the following detailed description example sizes/models/values/ranges may be given with respect to specific embodiments but are not to be considered generally limiting. Though a parallel hybrid-electric vehicle is used for illustration, the principals taught here are readily extended to an all electric vehicle or a series hybrid-electric vehicle.

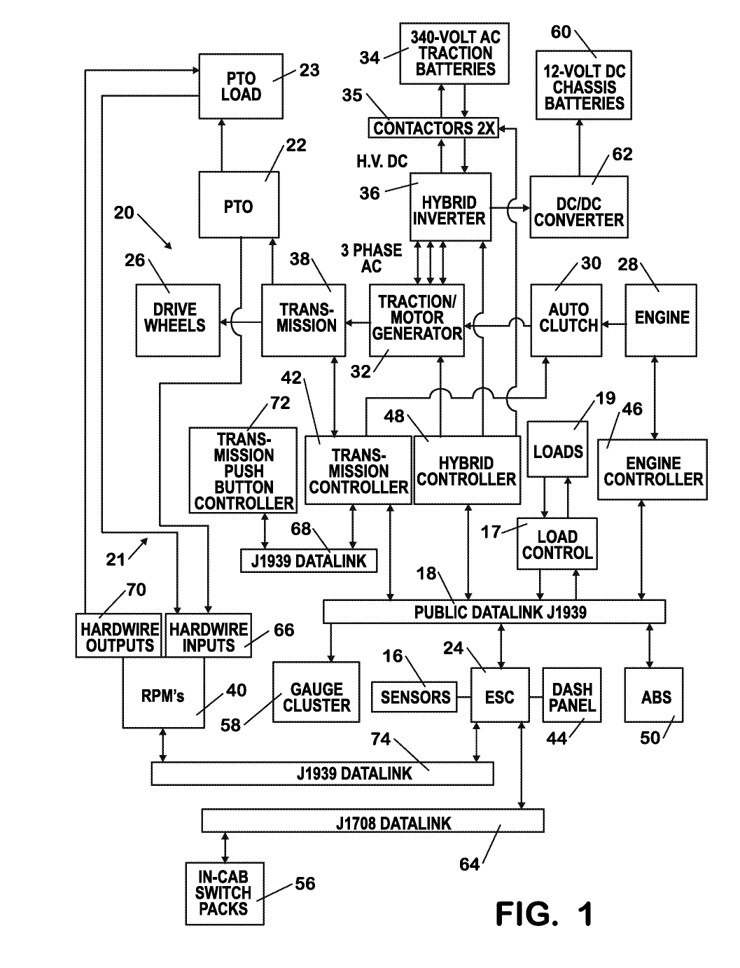

Referring to FIG. 1, a high level schematic of a control system 21 which provides control and energy use management for a vehicle drive train 20 is illustrated. An electrical system controller (ESC) 24, a type of a body computer, operates as a system supervisor and is linked by a public data link 18 to a variety of local controllers which in turn implement direct control over vehicle functions not directly controlled by the ESC 24. As may be inferred, ESC 24 is typically directly connected to selected inputs (including sensors) and outputs. A sensors package 16 represents such sensors and may include a brake pedal position sensor, a throttle position sensor and abrupt deceleration sensors. In addition ESC 24 communicates with a dash panel 44 from which it may obtain signals indicating ignition state, headlight on/off switch position and provide on/off signals to other items, such as headlights (not shown). Signals relating to a power take-off operation (PTO) are communicated between an in cab switch pack 56 and ESC 24 over a SAE J1708 compliant data link 64. Data link 64 is a low baud rate data connection, typically about 9.7K baud.

Six representative local controllers in addition to the ESC 24 are illustrated as connected to the public data link 18. These controllers include an engine controller 46, a transmission controller 42, a hybrid controller 48, a gauge controller 58 and an anti-lock brake system controller (ABS) 50. It will be understood that other controllers may be installed on the vehicle in communication with data link 18. These controllers both control various vehicle electrical loads and represent loads themselves. These additional controllers are represented by a generic “load” controller 17 for the control of loads 19. Various sensors may be connected to several of the local controllers. Data link 18 is preferably the bus for a public controller area network (CAN) conforming to the SAE J1939 standard and under current practice supports data transmission at up to 250K baud.

Hybrid controller 48, transmission controller 42 and engine controller 46 coordinate operations of the drive train to select between the engine 28 and the traction motor 32 as the prime mover for the vehicle (or to combine the output of the engine and the fraction motor if called for). During braking these same controllers coordinate disengagement and shut-down of engine 28 and operation of traction motor 32 in its generator mode to recapture the vehicle's kinetic energy. The ESC 24 and the ABS controller 50 provide data over data link 18 used for these operations, including brake pedal position, data relating to skidding, throttle position and other power demands such as for PTO 22. The hybrid controller further monitors a proxy relating to battery 34 state of charge (SOC).

Drive train 20 is a parallel hybrid diesel electric system in which the traction motor/generator 32 is connected in line with an engine 28 through an auto-clutch 30 so that the engine 28, the traction motor 32, or both in combination, can function as the vehicle's prime mover. As with other hybrid designs, the system is intended to recapture a vehicle's inertial momentum and store it as potential energy for later use including reinsertion to the drive train 20. In a parallel hybrid-electric vehicle the traction motor/generator 32 is used to recapture vehicle kinetic energy during deceleration by using the drive wheels 26 to back drive the traction motor/generator 32, capturing a portion of the vehicle's kinetic energy by generating electricity therefrom. Engine 28 is disengaged from the other components in drive train 20 by opening auto-clutch 30 during periods when the traction motor 32 is back driven.

Transitions between positive and negative traction motor 32 electrical power consumption are detected and managed by a hybrid controller 48. Traction motor/generator 32, during braking, generates three phase alternating current which is applied to an inverter 36 for conversion to direct current (DC) and then through contactors 35 to traction battery plant battery 34. When the traction motor 32 is used as a vehicle prime mover the flow of power is reversed. Battery 34 is usually a lithium ion battery plant and may be supplemented as a source of stored electrical power, for example, by a conventional 12 volt battery.

High mass vehicles tend to exhibit poorer gains from hybrid locomotion than do automobiles. Thus electrical power available from fraction battery 34 is often used to power other vehicle systems such as a PTO device 22 based on an electric motor (such PTO systems may include a manned “cherry picker”, a motor for a winch, etc). The traction motor 32 itself may provide the motive power for the PTO device 22 (such as a hydraulic motor). In addition, traction motor/generator 32 may be used for starting engine 28. If requests for such operations were honored contemporaneously with a transition of contactors 35 to a closed position substantial current could be drawn from the traction battery 34 to support such operations before the contactors 35 closed resulting in arcing before the contactors were fully closed.

The various local controllers may be programmed to respond to data from ESC 24 passed to data link 18. Hybrid controller 48 determines, based on available battery charge state, requests for power. Hybrid controller 48 with ESC 24 generates the appropriate signals for application to data link 18 for instructing the engine controller 46 to turn engine 28 on and off and, if on, at what power output to operate the engine. Transmission controller 42 controls engagement of auto clutch 30. Transmission controller 42 further controls the state of transmission 38 in response to transmission push button controller 72, determining the gear the transmission is in or if the transmission is to deliver drive torque to the drive wheels 26 or to a hydraulic pump which is part of PTO system 22 (or simply pressurized hydraulic fluid to PTO system 22 where transmission 38 serves as the hydraulic pump) or if the transmission is to be in neutral.

PTO control is implemented through one or more remote power modules (RPMs) 40. Remote power modules 40 are data linked expansion input/output modules dedicated to the ESC 24, which is programmed to utilize them. RPMs 40 function as the controller for PTO 22, and provide any hardwire outputs 70 and hardwire inputs 66 associated with the PTO device 22 and possibly to and from a PTO load 23. Requests for operation of load 23 and potentially response reports are applied to the data link 74 for transmission to the ESC 24, which translates them into specific requests for the other controllers, e.g. a request for power. ESC 24 is also programmed to control valve states through RPMs 40 in PTO device 22. Remote power modules are more fully described in U.S. Pat. No. 6,272,402 which is assigned to the assignee of the present invention and is fully incorporated herein by reference. At the time the '402 patent was written what are now termed “Remote Power Modules” were called “Remote Interface Modules”.

If a supplementary 12 volt system is present some electrical power may be diverted from hybrid inverter 35 to maintain the charge of a conventional 12-volt DC chassis battery 60 through a DC/DC inverter 62. Twelve volt DC motor vehicle power systems based on an engine driven alternator and 12 volt, 6 cell lead acid batteries have been in use for decades and are well known to those skilled in the art. In vehicles contemporary to the writing of this application numerous 12 volt applications remain in common use and a hybrid electric vehicle incorporating drive train 20 may be equipped with a supplemental 12 volt system to support such systems. In such cases electrical power may be diverted from hybrid inverter 36 to a DC/DC inverter 62 which steps power down to maintain a charge on a conventional 12-volt DC chassis battery 60. Inclusion of such a parallel system would allow the use of readily available and inexpensive components designed for motor vehicle use, such as incandescent bulbs for illumination. Otherwise the use of 12 volt components carries a weight penalty and adds complexity to the vehicle. Battery 34 is sometimes referred to as a traction battery to distinguish it from the supplemental 12 volt battery 60.

Transmission controller and ESC 24 both operate as portals and/or translation devices between the various data links 68, 18, 74 and 64. Data links 68 and 74 may be proprietary and operate at substantially higher baud rates than does the public data link 18, and accordingly, buffering is provided for a message passed from one link to another. Additionally, a message may have to be reformatted, or a message on one link may require another type of message on the second link, e.g. a movement request over data link 74 may translate to a request for transmission engagement from ESC 24 to transmission controller 42. Data links 18, 68 and 74 are usually controller area network buses and may conform to the SAE J1939 protocol.

On heavy hybrid vehicles where the high voltage isolation contactors 35 separate the stored energy in the hybrid system's traction batteries 34 from the rest of the hybrid, the movable parts can become welded together as a result of transitions (the opening and closing) of the high voltage isolation contactors 35 while the high voltage system is under load. Welding can be further exacerbated by additional current loads originating from the chassis' electrical system and sub-electrical systems which are carried by the hybrid high voltage system by way of the hybrid system's DC to DC converters 62 at the time of the high voltage isolation contactor 35 transitions resulting in arcing and welding of the contactors.

Control system 21 implements cooperation of the control elements to order vehicle operations to minimize current draw during contactor 35 transitions. Chassis imposed electrical loads are reduced before, during and after the opening and or closing of the high voltage hybrid isolation contactors 35. A reconfigurable software and an electrical hardware architecture coordinates the turning on and turning off of current loads imposed by the chassis electrical system and or its sub-electrical system coordinated with the opening and closing of the hybrid system's high voltage contactors. Changes of state occurring among sensors 16 or on dash panel 44 can operate as indicators of an incipient demand for a transition of contactors 35. For example, movement of an ignition switch from OFF to ON or START will likely trigger a demand to close contactors 35. An indication of abrupt deceleration from sensors used to trigger deployment of air bags may be used as a trigger to open the contactors 35.

The existing vehicle data link environment allows control over the operation of the vehicle's hybrid-electric drive train 20 and various loads represented by loads 19, PTO 22, DC/DC inverter 62 and the various local controllers, for example the ABS controller 50, all of which draw power. Vehicle components, systems and subsystems such as: the chassis load manager, electric condenser pusher fans, electrified accessories (AC compressor, power steering, air compressor DC to DC converters and the like), truck equipment manufacture (TEM) installed equipment (lights, motors, solenoids and the like) are all subject to central control. With fully integrated load management system between the chassis, TEM installed equipment and the hybrid electric power electronics system electrical current loads are reduced as much as possible during the actual opening and closing of the hybrid high voltage contactors.

Implementation of load control is through a controller area network (CAN) communication strategy where different CAN modules/local controllers communicate over a data link environment (including data link 18) to control various chassis electrical loads (including loads 19 and PTO 22) and the various local controllers in conjunction with the opening and closing of two hybrid high voltage isolation contactors 35. High voltage isolator contactors 35 have a default open state and an energized (closed) state. For example, a transition from the open state to their closed state would be associated with cycling of the in-can key switch to its “On” state initializing the hybrid electric system and the vehicle control system.

The hybrid controller 48, which typically controls the hybrid high voltage isolation contactors 35 (alternatively these may be controlled by the ESC 24), sends an encoded digital message to the body controller (ESC 24) over the data 18 requesting the ESC, through its own physical outputs 44 or through a secondary CAN module such as the remote power module (RPM) 40, turn off or reduce all “non-critical” electrical loads 19, 22 in anticipation of the hybrid controller 48 closing of the hybrid high voltage isolation contactors 35. Once the ESC 24 (either directly, through the RPM 40 or through other controllers) has turned “Off” and, or reduced all available electrical loads under the present vehicle mode of operation, or delayed a load from turning on, the ESC 24 then transmits encoded digital message over the data link 18 containing the instant loading status of the chassis electrical system. This status communication can be as simple as broadcasting a discrete message indicating that the electrical loads that can be turned “Off”, or be reduced, have been turned “Off” or reduced to their fullest extent. The status communication could also contain actual or calculated current loads. Once the hybrid controller 48 receives the ESC 24 status message, it then can decide to transition the hybrid high voltage isolation contactors 35 from their current state or maintain them in their present state based on the information contained in the message status.

PTO devices 22 are a good example of the flexibility which may be incorporated into the present system. Normally PTO 22 would be a lead candidate for shut down or reduced level operation on a contactors 35 transition. However, whether or not operation of the PTO 22 can be discontinued on particular transition event can be left to the operator's determination based on the character and circumstances of the transition event.

An initialization timer is also provided, typically through appropriate programming of the ESC 24. The purpose of the initialization timer is to create an interval of time during the activation of the hybrid system (such as turning “On” the in-cab key switch) which automatically turns “Off” or reduces a series of predetermined loads. These loads are turned “Off” or reduced for a programmable interval of time minimizing the current loading imposed on the hybrid high voltage isolation contactors 35 prior to all associated controllers involved in the normal load management process becoming fully initialized. By the time the initialization timer expires, all involved controllers should have had adequate time to initialize and assume the normal mode of load management functionality as describe in the first part of this teaching.

By managing loads the amount of current being carried through the hybrid high voltage isolation contactors 25 during their transitions is reduced whereby premature failure and weld issues are mitigated.

The control of various loads originating from the chassis' electrical system and sub-electrical systems is based on “logical” and data link signals. This allows for customization of vehicle equipment features and functionality with little to no changes to actual vehicle hardware architecture. Due to the data link and software driven character of the control arrangements the control of particular loads may be conditional upon the operating mode of the vehicle and allows selection of vehicle loads to cut off or restrict based on whether the transition is from opened to closed or closed to opened. For example, windshield wiper function through the dash panel 44 or load controller 17 may be shed if the vehicle is in a stationary mode of operation and the headlights are off. Under other circumstances windshield wipers may be a priority function which is maintained through a transition of the contactors 35. Examples of loads that may be considered for mode sensitive availability for turning off or reducing for transitions include headlights, marker lights, heating, ventilation and air conditioning blower motors, electrically powered power steering, electric air compressors, truck equipment manufacturer (TEM) accessories, electric cooling fans, various system controllers (e.g. the ABS controller 50 if the vehicle is stationary and the parking brake is set).

Costs are reduced since this system uses the existing vehicle architecture. System robustness is enhanced by using the data link and controller environment. Increased robustness enhances safety by improving the chances that contactors 35 will open in case of a accident to reduce voltages on exposed portions of the vehicle electrical system.

What is claimed is:

1. A vehicle, comprising:
a high voltage electrical system;
traction batteries;
contactors between the traction batteries and the high voltage electrical system, the contactors having a closed state and an opened state;
a plurality of vehicle electrical loads;
sensors for indicating vehicle operating conditions;
a vehicle control system coupled to receive output signals generated by the sensors including output signals generating a transition in state of the contactors and including means for controlling transition in the state of the contactors and further including means for controlling the amount of electricity each vehicle electrical load can draw; and
the vehicle control system being responsive to vehicle operating conditions generating a change in state of the of the contactors for reducing the current draw of the plurality of vehicle loads.

2. The vehicle as set forth in claim 1, further comprising:
the vehicle control system being programmed to provide selection of vehicle electrical loads for reduction in response to different vehicle operating conditions.

3. The vehicle as set forth in claim 1, further comprising:
the vehicle control system being programmed to provide selection of vehicle electrical loads for reduction in response to the state transition being from opened to closed and from closed to opened.

4. The vehicle as set forth in claim 2, further comprising:
the vehicle control system being programmed to provide selection of vehicle electrical loads for reduction in response to the state transition being from opened to closed and from closed to opened.

5. The vehicle as set forth in claim 4, wherein the vehicle has a hybrid electric drive train and the hybrid electric drive train includes an electric traction motor and an internal combustion engine wherein either the internal combustion engine or the electric traction motor can operate as the vehicle prime mover.

6. A traction battery isolation system for a vehicle comprising:
battery contactors having a closed state and an open state;
means for establishing vehicle operating conditions;
control means responsive to vehicle operating conditions for moving the battery contactors between states;
a plurality of vehicle electrical loads; and
the control means being further responsive to particular vehicle operating conditions for selecting vehicle electrical loads for limited operation during a state transition of the battery contactors.

7. The traction battery isolation system of claim 6, further comprising:
the selection of vehicle loads by the control means being further responsive to whether the state transition of the contactors is from closed to opened or from opened to closed.

8. The traction battery isolation system of claim 7, further comprising:
the selection of vehicle loads by the control means being further responsive to changes in vehicle operating conditions.

9. In a hybrid-electric or electric vehicle equipped with an electrical power distribution system, a plurality of loads which can draw current from the electrical power distribution system, a traction battery plant and contactors having closed and open states for coupling or isolating the traction battery plant from the electrical power distribution system, a method of operating the contactors comprising the steps of:
responsive to a change in vehicle operating conditions selecting loads for operation during a transition in state of the contactors;
implementing a transition in state of the contactors; and
selecting loads for operation based on vehicle operating conditions following completion of the transition in state of the contactors.
